(19) United States
(12) Patent Application Publication
(10) Pub. No.: US 2024/0005614 A1
(43) Pub. Date: Jan. 4, 2024

(54) INFORMATION PROCESSING APPARATUS AND NON-TRANSITORY STORAGE MEDIUM

(71) Applicant: TOYOTA JIDOSHA KABUSHIKI KAISHA, Toyota-shi (JP)

(72) Inventors: Toshiki KASHIWAKURA, Nagakute-shi (JP); Takahiro AOKI, Nagoya-shi (JP); Tsuyoshi OKADA, Nagoya-shi (JP); Hiromitsu FUJII, Kariya-shi (JP)

(21) Appl. No.: 18/343,786

(22) Filed: Jun. 29, 2023

(30) Foreign Application Priority Data
Jun. 30, 2022 (JP) 2022-106448

(51) Int. Cl. G06T 19/00; G06Q 10/02; G06Q 50/30

(52) U.S. Cl. CPC G06T 19/006; G06Q 10/02; G06Q 50/30

(57) ABSTRACT

An information processing apparatus is a computer carried by a first user who is arranged to get on an on-demand bus. The information processing apparatus includes a display device and a controller. The controller of the information processing apparatus creates an AR image by superimposing a first virtual image on a first real image obtained by photographing a first real scene at the position corresponding to the pick-up location for the first user in it. The first virtual image is a virtual image of a bus stop. Then, the controller causes the display apparatus to display the AR image thus created.

### CROSS REFERENCE TO THE RELATED APPLICATION

This application claims the benefit of Japanese Patent Application No. 2022-106448, filed on Jun. 30, 2022, which is hereby incorporated by reference herein in its entirety.

### BACKGROUND

### Technical Field

The present disclosure relates to an information processing apparatus and a non-transitory storage medium.

### Description of the Related Art

There is a known vehicle operation control system configured to obtain location information of a user who is arranged to get on a vehicle that runs along a predetermined route, set a provisional stop at which the user is to get on the vehicle using the location information, and inform the user of the location of the provisional stop (see, for example, Patent Literature 1 in the following citation list).

### CITATION LIST

### Patent Literature

Patent Literature 1: Japanese Patent Application Laid-Open No. 2021-51431.

### SUMMARY

An object of this disclosure is to provide a technology that makes it easy to find a pick-up location for the on-demand bus.

In one aspect of the present disclosure, there is provided an information processing apparatus carried by a first user who is arranged to get on (or be picked up by) an on-demand bus. The information processing apparatus may include, in an exemplary mode:
a display device capable of displaying an image; and
a controller including at least one processor, configured to cause the display apparatus to display a first virtual image indicating a bus stop in association with a first real scene including the pick-up location for the first user.

In another aspect of the present disclosure, there is provided a non-transitory storage medium storing a program relating to a computer carried by a first user arranged to get on an on-demand bus. The non-transitory storage medium may store, in an exemplary mode, a program configured to cause the computer to display a first virtual image indicating a bus stop on a display device in association with a first real scene including the pick-up location for the first user.

In other another aspect of the present disclosure, there is also provided an information processing method for implementing the above-described processing of the information processing apparatus by a computer.

According to the present disclosure, there is provided a technology that makes it easy to find a pick-up location for the on-demand bus.

### BRIEF DESCRIPTION OF THE DRAWINGS

FIG. 1 is a diagram illustrating the general outline of an on-demand bus system according to an embodiment.

FIG. 2 is a diagram illustrating exemplary hardware configurations of a server apparatus and a user's terminal included in the on-demand bus system according to the embodiment.

FIG. 3 is a block diagram illustrating an exemplary functional configuration of the user's terminal according to the embodiment.

FIG. 4 illustrates an example of information stored in a reservation management database.

FIG. 5 illustrates an example of a menu screen of an on-demand bus service.

FIG. 6 illustrates an example of a screen indicating a reservation list.

FIG. 7 illustrates an example of a screen indicating details of a reservation.

FIG. 8 illustrates an example of a screen displaying an AR image according to the embodiment.

FIG. 9 is a flow chart of a processing routine executed in the user's terminal according to the embodiment.

FIG. 10 illustrates an example of a screen displaying an AR image according to a first modification.

FIG. 11 illustrates an example of a screen displaying an AR image according to a second modification.

FIG. 12 illustrates an example of a screen displaying an AR image according to a third modification.

### DESCRIPTION OF THE EMBODIMENTS

On-demand buses have become widespread recently, which operate with the user's designation of the location and the date and time of pick-up. The on-demand bus operates according to the pick-up location and the pick-up date and time that are freely determined by the user, unlike regularly operated fixed-route buses, such as scheduled buses and highway buses. Hence, pick-up locations for the on-demand bus may not have a mark or sign like a bus stop sign that the bus stops of the regularly operated fixed-route buses have.

In the case where a location that does not have a bus stop sign is used as a pick-up location for the on-demand bus, it may be difficult for the user to find the pick-up location. Moreover, the user may be uncertain as to whether the location where he or she is waiting for the on-demand bus is the correct pick-up location. Given the above situation, a measure that makes it easy for the user to find the pick-up location is desired.

An information processing apparatus disclosed herein has a controller configured to cause a display device to display a first virtual image as a virtual image of a bus stop for an on-demand bus in association with a first real scene. The information processing apparatus is a small computer provided with the display device carried by a first user who is arranged to get on (or to be picked up by) the on-demand bus. The first real scene is a real scene including the location of pick-up of the first user, in other words, a real scene including (or a real view of) the location of pick-up of the first user and its vicinity.

In this disclosure, the expression “to cause a display device to display a first virtual image in association with a first real scene including the location of pick-up of the first user” shall also be construed to cause a display device to display an AR image created by superimposing the first virtual image on an image (referred to as a first real image) obtained by capturing (or photographing) the first real scene. In this case, the first virtual image is superimposed on the first real image at the position corresponding to the pickup location in the first real image.

In the case where the information processing apparatus according to the present disclosure is a computer provided with a see-through display device, such as smart glasses, the first virtual image may be displayed in the area of the display corresponding to the pick-up location, while the first real scene is seen through the display device.

The information processing apparatus according to the present disclosure enables the first user to find the location of pick-up by viewing the first virtual image associated with the first real scene. The information processing apparatus according to the present disclosure can reduce the uncertainty of the first user as to whether the location where he or she is waiting for the on-demand bus is the correct location of pick-up.

### EMBODIMENT

In the following, a specific embodiment of the technology disclosed herein will be described with reference to the drawings. The features that will be described in connection with the embodiment are not intended to limit the technical scope of the disclosure only to them, unless otherwise stated. In the following description of the embodiment, a case where the information processing apparatus according to the present disclosure is applied to an on-demand bus system will be described.

(Outline of On-Demand Bus System)

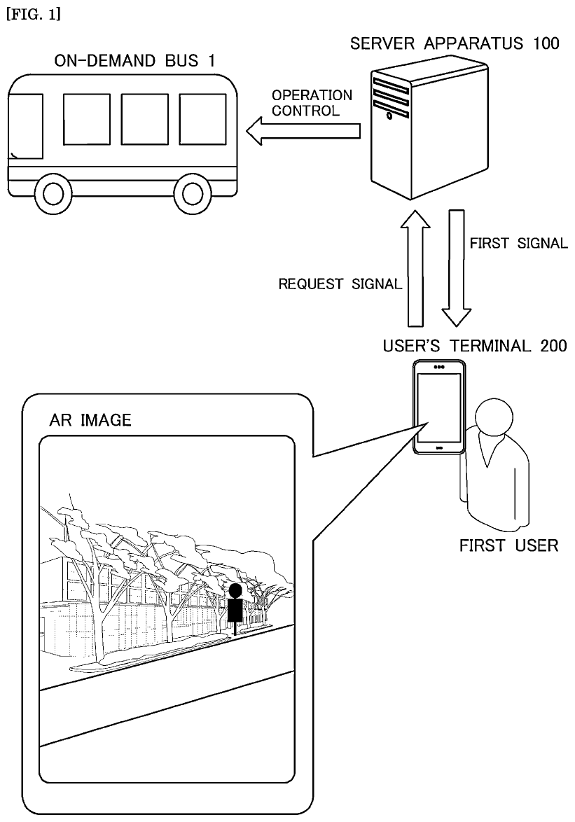

FIG. 1 illustrates the general configuration of an on-demand bus system according to the embodiment. The on-demand bus system according to the embodiment includes a server apparatus 100 that manages the operation of an on-demand bus 1 and a user's terminal 200 used by a user of the on-demand bus 1, who will be referred to as the “first user”. The server apparatus 100 and the user's terminal 200 are connected through a network N1. While FIG. 1 illustrates only one user's terminal 200 by way of example, the on-demand bus system can include a plurality of user's terminals 200.

The on-demand bus 1 is a vehicle that is operated according to a pick-up location and a pick-up date and time that are specified by the first user. Alternatively, the on-demand bus 1 may be a vehicle that is operated according to a predetermined operation route and operation time, and only the pick-up location may be changed according to a request by the first user.

The server apparatus 100 receives a request relating to arrangement of the on-demand bus 1 from the first user and creates an operation plan for the on-demand bus 1. The request from the first user contains information about a pick-up location, a pick-up date and time, a drop-off location, and a drop-off date and time that the first user desires. A signal of such a request is sent from the user's terminal 200 used by the first user to the server apparatus 100 through the network N1. The operation plan includes an operation route of the on-demand bus 1, locations at which the on-demand bus 1 is to stop in the operation route (namely, the pick-up location and drop-off location for the first user), and the operation time. The pick-up location and the drop-off location for the first user are basically set to the locations requested by the first user. However, if the pick-up location and/or the drop-off location requested by the first user is not suitable for the on-demand bus to stop at, the provider of the on-demand bus service may set locations in the vicinity of the pick-up location and/or the drop-off location requested by the first user that are suitable for the on-demand bus to stop at as the pick-up location and/or the drop-off location for the first user. In the case where the pick-up location and/or the drop-off location for another (or second) user has already been set in the vicinity of the pick-up location and/or the drop-off location requested by the first user, the provider of the on-demand bus service may set the pick-up location and/or the drop-off location for the first user to the locations or location same as the pick-up location and/or the drop-off location for the second user.

The server apparatus 100 according to the embodiment also has the function of transmitting a first signal containing location information of the pick-up location to the user's terminal 200 after a reservation according to the above request is completed, in other words, after the pick-up location, the drop-off location, the pick-up date and time, and the drop-off date and time for the first user are determined. The location information of the pick-up location may be, for example, information indicating the latitude and longitude of the pick-up location. The first signal may contain data of an image obtained by capturing (or photographing) a real scene including the pick-up location.

The user's terminal 200 is a portable computer used by the first user. The user's terminal 200 has the function of receiving the entry of the above-described request conducted by the first user and transmitting a request signal according to the received request to the server apparatus 100.

The user's terminal 200 according to the embodiment also has the function of creating an AR (Augmented Reality) image based on the first signal received from the server apparatus 100 and presenting the created AR image to the first user. The AR image according to the embodiment is an image created by superimposing a first virtual image on a first real image. The first virtual image is a virtual image indicating the pick-up location for the on-demand bus 1, which may be, for example, a virtual image of a bus stop sign. The first real image is an image obtained by capturing a real scene of an area including the pick-up location for the first user (namely, a real scene including the pick-up location and its vicinity). The first virtual image is superimposed on the first real image at the position corresponding to the pick-up location in it. In the system according to the embodiment, the creation and presentation of the aforementioned AR image is performed when the first user arrives in the vicinity of the pick-up location and takes an image of the first real scene with the camera 204 of the user's terminal 200.

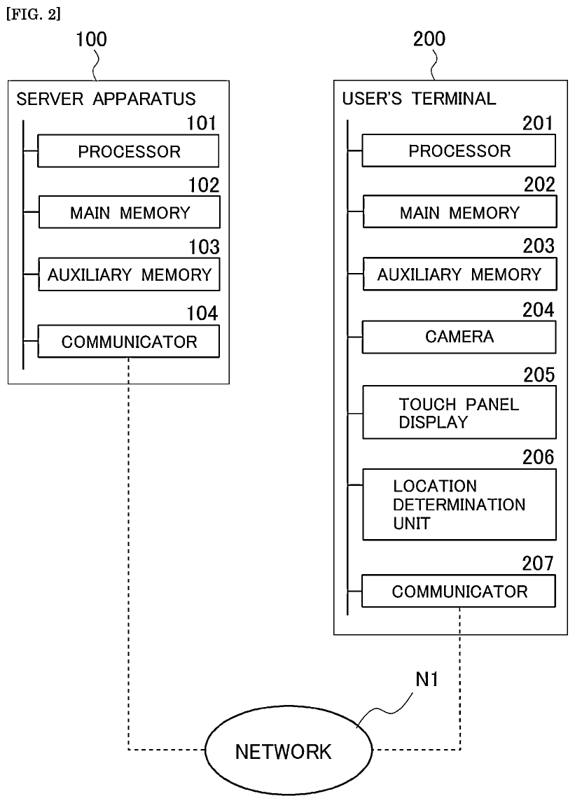

(Hardware Configuration of On-Demand Bus System) The hardware configuration of the on-demand bus system according to the embodiment will be described with reference to FIG. 2. FIG. 2 illustrates an example of the hardware configurations of the server apparatus 100 and the user's terminal 200 included in the on-demand bus system illustrated in FIG. 1. Although FIG. 2 illustrates only one user's terminal 200, the on-demand bus system actually includes user's terminals 200 as many as the users of the on-demand bus 1.

The server apparatus 100 is a computer that manages the operation of the on-demand bus 1. The server apparatus 100 is run by the provider of the on-demand bus service. As illustrated in FIG. 2, the server apparatus 100 includes a processor 101, a main memory 102, an auxiliary memory 103, and a communicator 104. The processor 101, the main memory 102, the auxiliary memory 103, and the communicator 104 are interconnected by buses.

The processor 101 may be, for example, a CPU (Central Processing Unit) or a DSP (Digital Signal Processor). The processor 101 executes various computational processing to control the server apparatus 100.

The main memory 102 is a storage device that provides a memory space and a work space into which programs stored in the auxiliary memory 103 are loaded and serves as a buffer for computational processing. The main memory 102 includes, for example, a semiconductor memory, such as a RAM (Random Access Memory) and a ROM (Read Only Memory).

The auxiliary memory 103 stores various programs and data used by the processor 101 in executing programs. The auxiliary memory 103 may be, for example, an EPROM (Erasable Programmable ROM) or a hard disk drive (HDD). The auxiliary memory 103 may include a removable medium or a portable recording medium. Examples of the removable medium include a USB (Universal Serial Bus) memory and a disc recording medium, such as a CD (Compact Disc) or a DVD (Digital Versatile Disc). The auxiliary memory 103 stores various programs, various data, and various tables in such a way that they can be written into and read out from it.

The programs stored in the auxiliary memory 103 include an operating system and programs used to create operation plans for the on-demand bus 1.

The communicator 104 is a device used to connect the server apparatus 100 to the network N1. The network N1 may be a WAN (Wide Area Network), which is a global public communication network like the Internet, or other communication network. The communicator 104 connects the server apparatus 100 to the user's terminal 200 through the network N1. The communicator 104 includes, for example, a LAN (Local Area Network) interface board or a wireless communication circuit for wireless communication.

In the server apparatus 100 configured as illustrated in FIG. 2, the processor 101 creates an operation plan for the on-demand bus 1 by loading a program stored in the auxiliary memory 103 into the main memory 102 and executing it. Specifically, when the communicator 104 receives a request signal transmitted from the user's terminal 200, the processor 101 determines an operation route and stop locations (i.e. the pick-up location and the drop-off location for the first user) of the on-demand bus 1 on the basis of the pick-up location and the drop-off location specified by the request signal. The server apparatus 100 determines an operation time of the on-demand bus 1 on the basis of the pick-up date and time and drop-off date and time specified by the request signal.

The process of determining the operation plan for the on-demand bus 1 is not limited to the process described above. For example, in the case where there is an on-demand bus 1 whose operation route and operation time have already been determined and that is scheduled to travel by the pick-up location specified by the first user at the pick-up date and time specified by the first user and by the drop-off location specified by the first user at the drop-off date and time specified by the first user, the operation plan for the on-demand bus 1 may be created by adding the pick-up location and the drop-off location specified by the first user as stop locations of the on-demand bus 1.

The operation plan including the operation route, the stop locations, and the operation time determined by the processor 101 is transmitted to a specific terminal through the communicator 104. In the case where the on-demand bus 1 is an autonomous vehicle capable of travelling autonomously, the specific terminal is a terminal provided on the on demand-bus 1. Then, the on-demand bus 1 can operate autonomously according to the operation plan created by the server apparatus 100. Alternatively, in the case where the on-demand bus 1 is a vehicle manually driven by a human driver, the specific terminal is a terminal used by the driver. Then, the driver can drive the on-demand bus 1 according to the operation plan created by the server apparatus 100.

When the reservation for the first user is completed in the server apparatus 100, the processor 101 transmits a first signal containing location information of the pick-up location for the first user to the user's terminal 200 through the communicator 104.

The hardware configuration of the server apparatus 100 is not limited to the example illustrated in FIG. 2, but some components may be added, removed, or replaced by other components. The processing executed in the server apparatus 100 may be executed by either hardware or software.

The user's terminal 200 is a small computer carried by the first user. The user's terminal constitutes an example of the information processing apparatus according to the present disclosure. The user's terminal 200 may be a mobile terminal, such as a smartphone or a tablet terminal. As illustrated in FIG. 2, the user's terminal 200 according to the embodiment includes a processor 201, a main memory 202, an auxiliary memory 203, a camera 204, a touch panel display 205, a location determination unit 206, and a communicator 207. The processor 201, the main memory 202, the auxiliary memory 203, the camera 204, the touch panel display 205, the location determination unit 206, and the communicator 207 are interconnected by buses.

The processor 201, the main memory 202, and the auxiliary memory 203 of the user's terminal 200 are similar to the processor 101, the main memory 102, and the auxiliary memory 103 of the server apparatus 100, and they will not be described further. In the auxiliary memory 203 of the user's terminal 200 is stored an application program for providing the on-demand bus service to the user. This application program will also be referred to as the “first application program” hereinafter.

The camera 204 is used to capture images of objects freely selected by the first user. For example, the camera 204 captures images of objects using a CCD (Charge Coupled Device) image sensor or a CMOS (Complementary Metal Oxide Semiconductor) image sensor.

The touch panel display 205 outputs images according to commands from the processor 201 and outputs signals input by the first user to the processor 201. The user's terminal 200 may be provided with a display device and an input device separately instead of the touch panel display 205.

The location determination unit 206 is a sensor that acquires location information indicating the present location of the user's terminal 200. For example, the location determination unit 206 may be a GPS (Global Positioning System) receiver. For example, the location information acquired by the location determination unit 206 is the latitude and longitude. The location determination unit 206 is not limited to a GPS receiver, and the location information acquired by the location determination unit 206 is not limited to the latitude and longitude.

The communicator 207 is a wireless communication circuit. The wireless communication circuit provides connection to the network N1 through wireless mobile communications, such as 5G (fifth generation), 6G, 4G, or LTE (Long Term Evolution) mobile communications. The wireless communication circuit may be configured to provide connection to the network N1 by WiMAX, Wi-Fi (registered trademark) or other wireless communication scheme. The communicator 207 is connected to the network N1 by wireless communication to communicate with the server apparatus 100.

The hardware configuration of the user's terminal 200 is not limited to the example illustrated in FIG. 2, but some components may be added, removed, or replaced by other components. The processing executed in the user's terminal 200 may be executed by either hardware or software.

(Functional Configuration of User's Terminal)

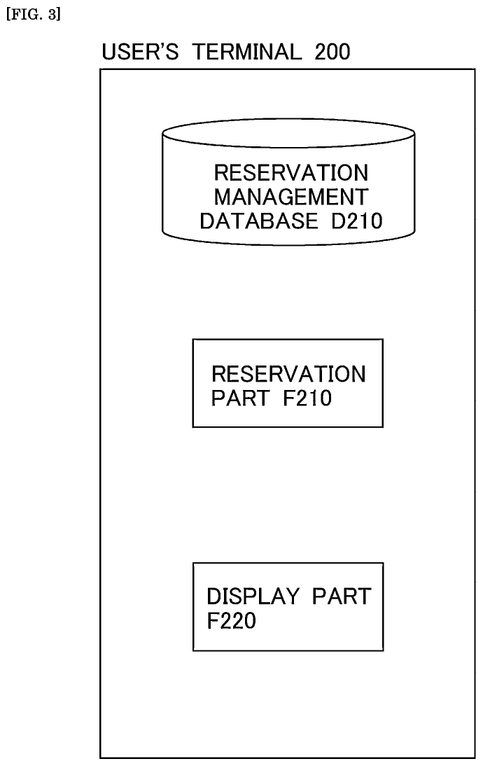

The functional configuration of the user's terminal 200 according to the embodiment will be described with reference to FIG. 3. The user's terminal 200 according to the embodiment includes, as functional components, a reservation management database D210, a reservation part F210, and a display part F220.

The reservation management database D210 is constructed by managing data stored in the auxiliary memory 203 by a database management system program (DBMS program) executed by the processor 201. The reservation management database D210 may be constructed as a relational database.

The reservation part F210 and the display part F220 are implemented by the processor 201 by executing the first application program stored in the auxiliary memory 203. The processor 201 that implements the reservation part F210 and the display part F220 corresponds to the controller of the information processing apparatus according to the present disclosure.

The reservation part F210, the display part F220, or a portion thereof may be implemented by a hardware circuit, such as An ASIC (Application Specific Integrated Circuit) or an FPGA (Field Programmable Gate Array). In this case, the hardware circuit corresponds to the controller of the information processing apparatus according to the present disclosure.

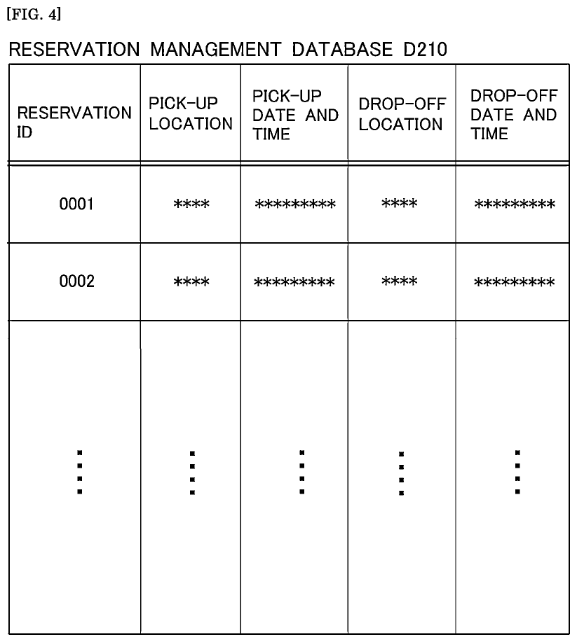

What is stored in the reservation management database D210 is information relating to on-demand buses 1 that have already been reserved. FIG. 4 illustrates an example of the information stored in the reservation management database D210. The reservation management database D210 illustrated in FIG. 4 stores records of respective reservations. Each record stored in the reservation management database D210 includes the fields of reservation ID, pick-up location, pick-up date and time, drop-off location, and drop-off date and time. Each record in the reservation management database D210 is created when the reservation of an on-demand bus 1 is completed.

What is stored in the reservation ID field is information for identifying each reservation (reservation ID). What is stored in the pick-up location field is location information of the pick-up location for the reserved on-demand bus 1. An example of the location information of the pick-up location is information specifying the latitude and longitude of the pick-up location. What is stored in the pick-up date and time field is information specifying the date and time of pick-up for the reserved on-demand bus 1. What is stored in the drop-off location field is location information of the drop-off location for the reserved on-demand bus 1. An example of the location information of the drop-off location is information specifying the latitude and longitude of the drop-off location. What is stored in the drop-off date and time field is information specifying the date and time of drop-off for the reserved on-demand bus 1.

The structure of the records stored in the reservation management database D210 is not limited to the example illustrated in FIG. 4, but some fields may be added, removed, or replaced by other fields.

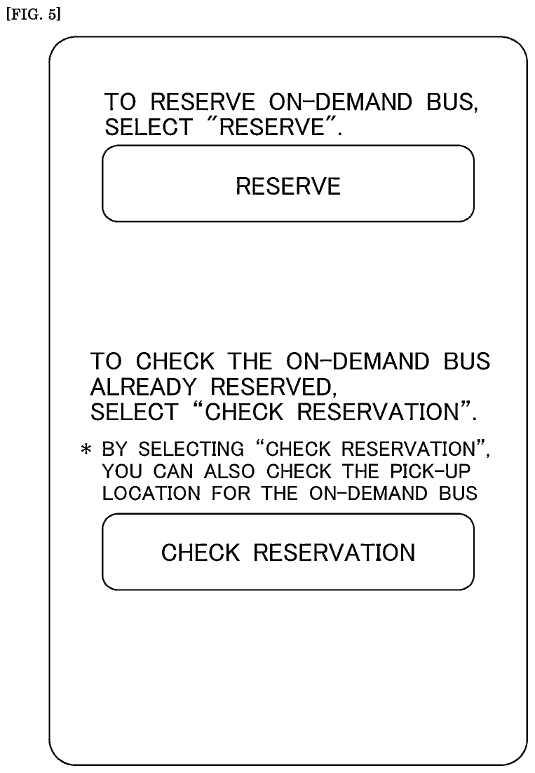

Referring back to FIG. 3, the reservation part F210 will be described next. When a user's operation for starting the first application program is entered to the user's terminal 200, the processor 201 loads the first application program stored in the auxiliary memory 203 into the main memory 202 and executes it. As the first application program is started, the reservation part F210 outputs a menu screen for the on-demand bus service on the touch panel display 205. FIG. 5 illustrates an example of the menu screen for the on-demand bus service. The exemplary screen illustrated in FIG. 5 includes the “Reserve” button, the “Check Reservation” button, and explanations of the buttons.

If the first user makes the operation of selecting the “Reserve” button on the touch panel display 205 illustrating the menu screen in FIG. 5, the reservation part F210 outputs a screen for the first user to enter a request (including information about a pick-up location, pickup date and time, drop-off location, and drop-off date and time that the first user desires) on the touch panel display 205. After the completion of the entry of the request by the first user, the reservation part F210 transmits a request signal to the server apparatus 100 through the communicator 207. The request signal contains identification information of the first user (i.e. user ID) in addition to information about the pick-up location, pick-up date and time, drop-off location, and drop-off date and time that the first user desires.

When the server apparatus 100 receives the above request signal, the server apparatus 100 determines the pick-up location, pick-up date and time, drop-off location, and drop-off date and time for the first user to make reservation of the on-demand bus 1. After the reservation of the on-demand bus 1 is completed, the server apparatus 100 transmits a first signal to the user's terminal 200. The first signal contains the reservation ID in addition to information about the pick-up location, pick-up date and time, drop-off location, and drop-off date and time determined by the server apparatus 100.

When the communicator 207 of the user's terminal 200 receives the first signal transmitted from the server apparatus 100, the reservation part F210 accesses the reservation management database D210 to create a new record. The information contained in the first signal is stored in the fields of the newly created record.

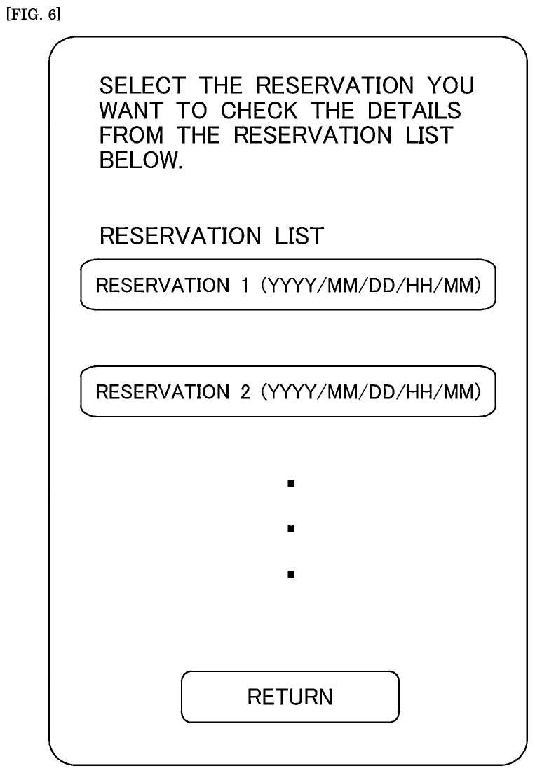

When the first user enters the operation of selecting the “Check Reservation” button on the touch panel display 205 illustrating the menu screen of FIG. 5, the reservation part F210 outputs a screen illustrating a list of the reserved on-demand buses 1 (reservation list) on the touch panel display 205. FIG. 6 illustrates an example of the screen indicating the reservation list. The exemplary screen illustrating the reservation list in FIG. 6 includes buttons for displaying the details of the respective reservations (namely, the “Reservation 1” button and the “Reservation 2” button in FIG. 6) and the “Return” button to return to the screen illustrated in FIG. 5.

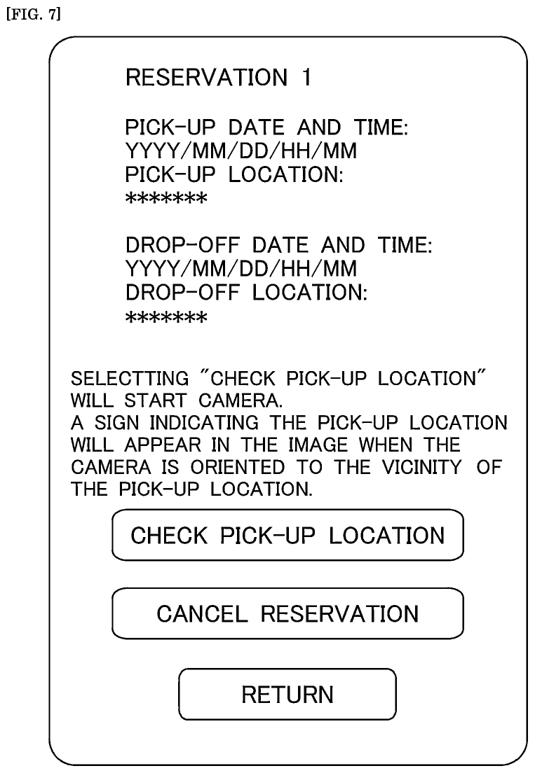

When the first user enters the operation of selecting one of the reservation button in the reservation list on the touch panel display 205 illustrating the reservation list screen of FIG. 6, the reservation part F210 outputs a screen illustrating the details of the reservation corresponding to the selected button on the touch panel display 205. FIG. 7 illustrates an example of the details of the reservation. In FIG. 7, the exemplary screen illustrating the details of the reservation includes character strings describing the details of the reservation selected by the first user (e.g. the pick-up location, the pick-up data and time, the drop-off location, and the drop-off date and time), an explanation of how to check the pick-up location, the “Check Pick-up Location” button, the “Cancel Reservation” button, and the “Return” button to return to the screen illustrated in FIG. 6. The pick-up location and the drop-off location in the details of the reservation may be specified by character strings describing their addresses instead of their latitudes and longitudes. Alternatively, map information having markings at the pick-up location and the drop-off location may be presented.

When the first user enters the operation of selecting the “Check Pick-up Location” button on the touch panel display 205 illustrating the reservation details screen of FIG. 7, the reservation part F210 passes location information (i.e. information specifying the latitude and longitude) of the pick-up location for the reservation in question to the display part F220. When the first user enters the operation of selecting the “Cancel Reservation” button on the touch panel display 205 illustrating the reservation details screen of FIG. 7, the reservation part F210 sends a request for cancelling the corresponding reservation to the server apparatus 100 through the communicator 207. When the user's terminal 200 receives a signal indicating the completion of cancellation of the reservation sent from the server apparatus 100 in response to the request, the reservation part F210 accesses the reservation management database D210 to delete the record of the corresponding reservation.

Referring back to FIG. 3, triggered by the reception of the location information of the pick-up location from the reservation part F210, the display part F220 causes the touch panel display 205 to display the first virtual image associated with the first real scene. Specifically, when the first user enters the operation of selecting the “Check Pick-up Location” button on the touch panel display 205 illustrating the reservation details screen of FIG. 7, the display part F220 executes the processing of creating and displaying an AR image. The AR image is an image created by superimposing the first virtual image (i.e. a virtual image of a bus stop sign) on the first real image (i.e. an image of a real scene including the pick-up location) at the position corresponding to the pick-up location in it.

In the process of creating the above AR image, the display part F220 firstly activates the camera 204 of the user's terminal and obtains an image captured by the camera 204. The display part F220 determines whether the image captured by the camera 204 includes the pick-up location. In other words, the display part F220 determines whether the image captured by the camera 204 is the first real image (i.e. an image created by capturing a real scene including the pick-up location).

If the image captured by the camera 204 is the first real image, the display part F220 superimposes the first virtual image on the first real image at the position corresponding to the pick-up location in it to create the AR image. The display part F220 outputs the AR image thus created on the touch panel display 205 of the user's terminal 200.

In the system of this embodiment, the determination as to whether the image captured by the camera 204 includes the pick-up location and the creation of the AR image are performed by a location-based method based on the location information of the pick-up location and information about the present location of the user's terminal 200 (i.e. location information acquired by the location determination unit 206). In the case where the user's terminal has sensors for determining the posture and the orientation, such as an acceleration sensor and a compass, information about the posture and the orientation of the user's terminal 200 may be used in addition to the location information of the pick-up location and the present location information of the user's terminal 200 in performing the above determination and the creation of the AR image. Alternatively, the determination as to whether the image captured by the camera 204 includes the pick-up location and the creation of the AR image may be performed by a vision-based method based on image recognition or space recognition.

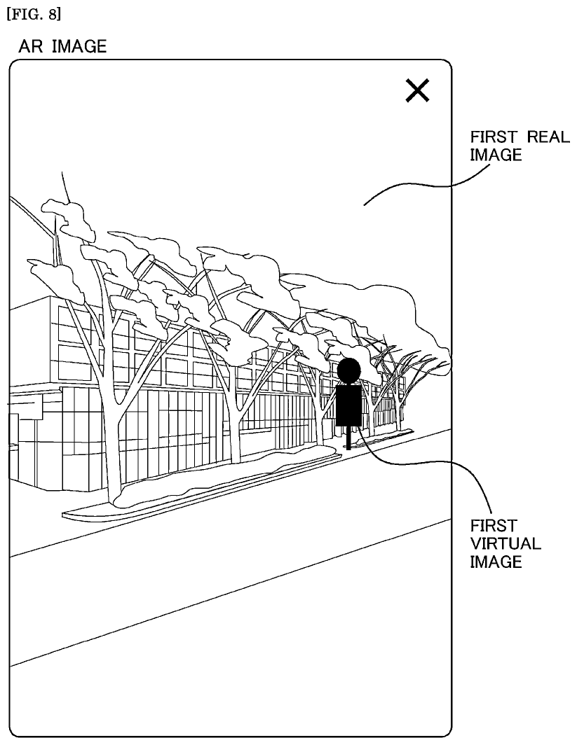

FIG. 8 illustrates an example of the display screen illustrating the AR image according to the embodiment. In the example illustrated in FIG. 8, the display screen of the AR image includes the first real image obtained by capturing a real scene including the pick-up location and its vicinity, the first virtual image indicating a bus stop sign superimposed thereon at the position corresponding to the pick-up location in it, and the “X” button to terminate the viewing of the pick-up location. The first user arriving in the vicinity of the pick-up location can grasp the precise pick-up location by viewing the display screen illustrated in FIG. 8.

As the first user operates the “X” button in the display screen illustrated in FIG. 8 after grasping the pick-up location, the display part F220 stops the operation of the camera 204 to terminate the display of the AR image. After the display of the AR image is terminated, the reservation part F210 causes the touch panel display 205 to display the screen of FIG. 7 described above.

If the image captured by the camera 204 is not the first real image (namely, an image including the pick-up location), the display part F220 causes the touch panel display 205 of the user's terminal 200 to simply display the image captured by the camera 204. Then, the first user will change the orientation of the camera 204 so that an AR image like that illustrated in FIG. 8 will be displayed.

(Process Executed in User's Terminal)

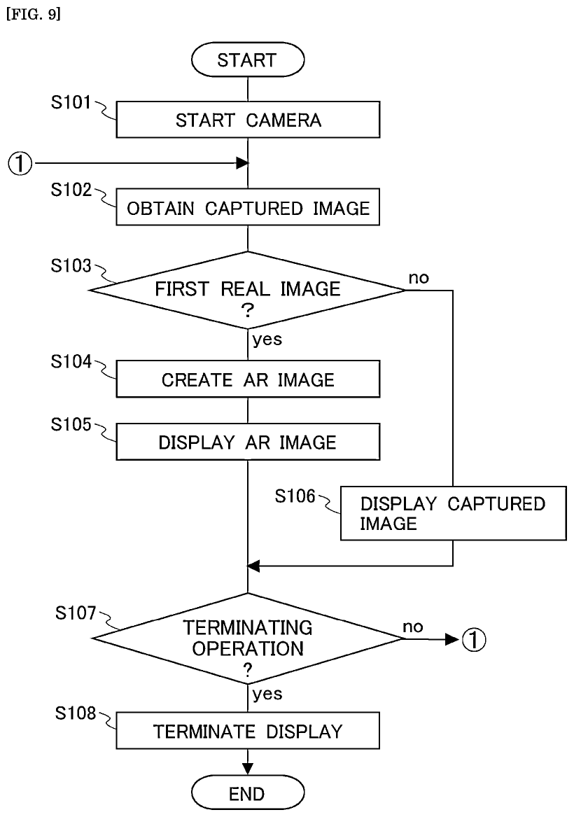

A process executed in the user's terminal 200 will now be described with reference to FIG. 9. FIG. 9 is a flow chart of a processing routine executed in the first user's terminal 200, which is triggered by the first user's entry of the operation of selecting the “Check Pick-up Location” button on the touch panel display 205 illustrating the reservation details screen of FIG. 7. While the processing routine according to the flow chart of FIG. 9 is executed by the processor 201 of the user's terminal 200, functional components of the user's terminal 200 will be mentioned in the following description as components that execute the processing in the routine.

In the processing routine according to the flow chart of FIG. 9, when the user arriving in the vicinity of the pick-up location operates the user's terminal to open the reservation details screen illustrated in FIG. 7 and conduct the operation of selecting the “Check Pick-up Location” button, the reservation part F210 passes the location information of the pick-up location to the display part F220. Triggered by the reception of the information from the reservation part F210, the display part F220 starts the camera 204 of the user's terminal 200 (step S101). After the completion of the processing of step S101, the display part F220 executes the processing of step S102.

In step S102, the display part F220 obtains an image captured by the camera 204. After the completion of the processing of step S102, the display part F220 executes the processing of step S103.

In step S103, the display part F220 determines whether the image captured by the camera 204 is the first real image. Specifically, the display part F220 determines whether the image captured by the camera 204 includes the pick-up location by the location-based method based on the location information of the pick-up location, the location information acquired by the location determination unit 206 (i.e. the present location information of the user's terminal 200), and the image captured by the camera 204. If the image captured by the camera 204 includes the pick-up location, the display part F220 determines that the image captured by the camera 204 is the first real image (affirmative answer in step S103). Then, the display part F220 executes the processing of step S104. If the image captured by the camera 204 does not include the pick-up location, the display part F220 determines that the image captured by the camera 204 is not the first real image (negative answer in step S103). Then, the display part F220 executes the processing of step S106.

In step S104, the display part F220 creates an AR image by compositing the image captured by the camera 204 (i.e. the first real image) and a virtual image of a bus stop sign (i.e. the first virtual image). Specifically, the display part F220 creates the AR image by superimposing the first virtual image on the first real image at the position corresponding to the pick-up location in it. After the completion of the processing of step S104, the display part F220 executes the processing of step S105.

In step S105, the display part F220 causes the touch panel display 205 of the user's terminal 200 to display the AR image created in step S104.

In step S106, the display part F220 causes the touch panel display 205 to display the image picked up by the camera 204 without any processing.

After the completion of the processing of step S105 or S106, the display part F220 executes the processing of step S107. In step S107, the display part F220 determines whether the operation of terminating the display of the AR image or the image captured by the camera 204 is entered. Specifically, the display part F220 determines whether the “X” button in the screen illustrated in FIG. 8 is operated. If the “X” button in the screen of FIG. 8 is not operated (negative answer in step S107), the display part F220 executes the processing of step S102 onward again. If the “X” button in the screen of FIG. 8 is operated (affirmative answer in step S107), the display part F220 executes the processing of step S108.

In step S108, the display part F220 stops the operation of the camera 204 to terminate the display of the AR image or the image captured by the camera 204 on the touch panel display 205. After the display of the AR image or the image captured by the camera 204 on the touch panel display 205 is terminated, the reservation part F210 causes the touch panel display 205 to display the above-described reservation details screen of FIG. 7 on the touch panel display 205.

### Operation and Advantageous Effects of Embodiment

According to the embodiment, when the first user is in the vicinity of the pick-up location, he or she can start the camera 204 of the user's terminal 200 through the first application program to cause the touch panel display 205 of the user's terminal 200 to display the AR image in which the first virtual image is superimposed on the first real image at the position corresponding to the pick-up location in it. Then, the first user, who views the AR image, can grasp the precise location for pick-up in the real space. Thus, the first user can find the precise pick-up location easily. Moreover, the system according to the embodiment can reduce the uncertainty of the first user as to whether the location where he or she is waiting for the on-demand bus 1 is the correct pick-up location.

### <First Modification>

The apparatus according to the above-described embodiment is configured to create an AR image in which the first virtual image is superimposed on the first real image is created and displayed. What will be described here as a first modification is an apparatus configured to create and display an AR image in which second and third virtual images are superimposed, in addition to the first virtual image, on the first virtual image. The second virtual image mentioned above is a virtual image indicating a location at which the first user is to wait until the on-demand bus 1 arrives at the pick-up location. The third virtual image mentioned above is a virtual image specifying the place of the first user in the boarding order.

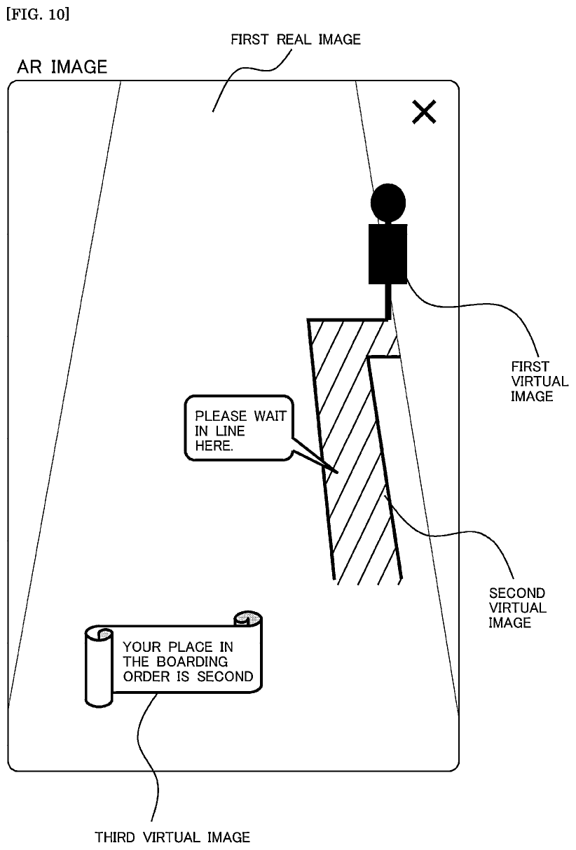

FIG. 10 illustrates an example of the display screen illustrating an AR image according to this modification. The exemplary screen of FIG. 10 illustrates an AR image including the first real image obtained by capturing a real scene including the pick-up location and its vicinity, the first virtual image superimposed on the first real image at the position corresponding to the pick-up location in it, the second virtual image superimposed on the first real image at the position corresponding to the location for waiting in it, the third virtual image superimposed on the first real image at a position in it other than the positions corresponding to the pick-up location or the location for waiting, and the “X” button to terminate the viewing of the pick-up location. The AR image is not limited to one including both the second and third virtual images, but the AR image may include only one of them.

In the case of this modification, the first signal contains location information of the location for waiting and information about the place of the first user in the boarding order in addition to location information of the pick-up location. The place of the first user in the boarding order may be determined, for example, based on the order of acceptance of reservation by the server apparatus 100. The display part F220 creates the second virtual image based on the location information of the location for waiting contained in the first signal and superimposes the second virtual image thus created on the first real image. Moreover, the display part F220 creates the third virtual image based on the information about the place of the first user in the boarding order contained in the first signal and superimposes the third virtual image thus created on the first real image. The position in the first real image at which the third virtual image is superimposed may be any position other than the positions at which the first and second virtual images are superimposed.

According to the first modification, the first user who views the AR image illustrated in FIG. 10 can grasp the pick-up location, the location for waiting, and his/her place in the boarding order. In consequence, the first user can wait for the arrival of the on-demand bus 1 without interfering with pedestrians. The system according to the first modification allows a plurality of users including the first user to get on the on-demand bus 1 according to a determined boarding order.

### <Second Modification>

The apparatus according to the above-described embodiment is configured to create an AR image in which the first virtual image is superimposed on the first real image is created and displayed. What will be described here as a second modification is an apparatus configured to create and display an AR image in which fourth and fifth virtual images are superimposed, in addition to the first virtual image, on the first virtual image. The fourth virtual image mentioned above is a virtual image indicating the number of other users who are waiting for the on-demand bus 1 at the pick-up location. The fifth virtual image mentioned above is a virtual image that marks another user who is waiting for the on-demand bus 1 at the pick-up location.

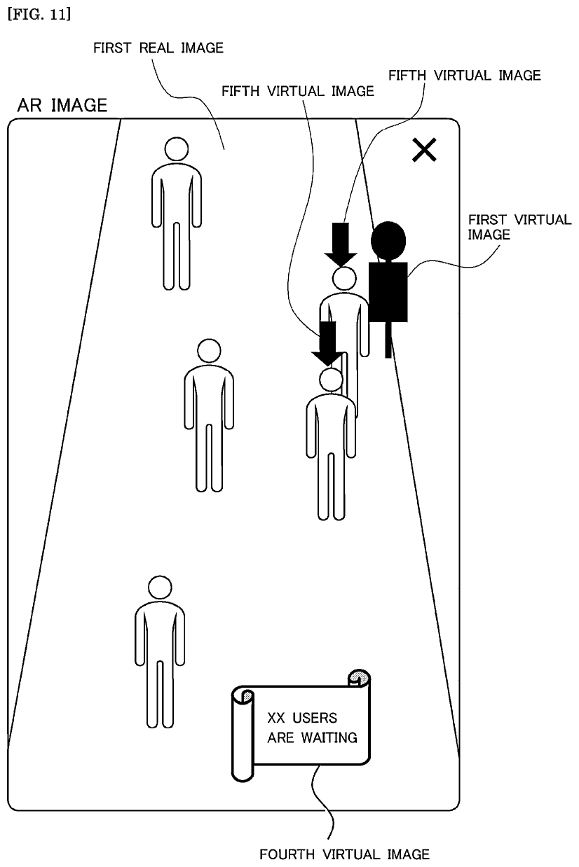

FIG. 11 illustrates an example of the display screen illustrating an AR image according to this modification. The exemplary screen of FIG. 11 illustrates an AR image including the first real image obtained by capturing a real scene including the pick-up location and its vicinity, the first virtual image superimposed on the first real image at the position corresponding to the pick-up location in it, the fourth virtual images superimposed on the first real image at a position in it other than the positions corresponding to the pick-up location or the locations of the other users, the fifth virtual image superimposed on the first real image at the positions in it corresponding to the locations of other users waiting for the on-demand bus 1 at the pick-up location, and the “X” button to terminate the viewing of the pick-up location. The AR image is not limited to one including both the fourth and fifth virtual images, but the AR image may include only one of them.

The display part F220 of the user's terminal 200 according to the second modification communicates with the server apparatus 100 through the communicator 207 to obtain location information of the other users who are waiting for the on-demand bus 1 at the pick-up location and information about the number of them on a real-time basis during the period from when the “Check Pick-up Location” button in the above-described reservation details screen of FIG. 7 is operated until when the “X” button in the display screen illustrating the AR image of FIG. 11 is operated. The display part F220 creates the fourth and fifth virtual images based on the information obtained from the server apparatus 100 and superimposes them on the first real image.

While in the example illustrated in FIG. 11, the fifth virtual image is an image of an arrow indicating another user waiting for the on-demand bus 1 at the pick-up location, the fifth virtual image may be an image other than the arrow image. For example, the fifth virtual image may be an image of a frame surrounding another user waiting for the on-demand bus 1 at the pick-up location or an image that paints another user waiting for the on-demand bus 1 at the pick-up location in a specific color.

According to the second modification, the first user who views the AR image illustrated in FIG. 11 can distinguish the other users who are waiting for the on-demand bus 1 at the pick-up location from the pedestrians present around the pick-up location.

### <Third Modification>

The apparatuses according to the embodiment and the first and second modifications are configured to use a virtual image of a bus stop sign as the first virtual image. What will be described here as a third modification is an apparatus configured to use a virtual image that marks a second user who is waiting for the on-demand bus 1 at the pick-up location as the first user. The second user is one of the other users who are waiting for the on-demand bus 1 at the pick-up location.

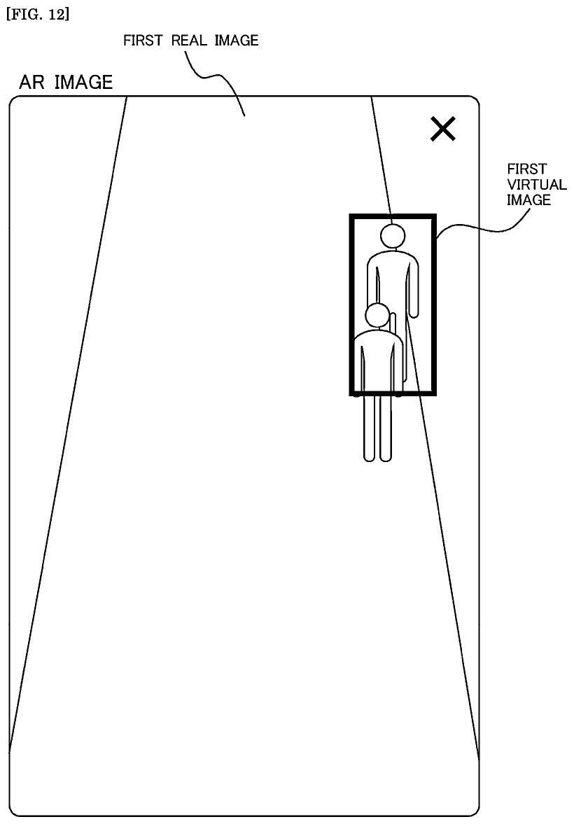

FIG. 12 illustrates an example of the display screen illustrating an AR image according to this modification. The exemplary screen of FIG. 12 illustrates an AR image including the first real image obtained by capturing a real scene including the pick-up location and its vicinity, the first virtual image that marks the second user who is waiting for the on-demand bus 1 at the pick-up location included in the first real image, and the “X” button to terminate the viewing of the pick-up location.

The display part F220 of the user's terminal 200 according to the third modification communicates with the server apparatus 100 through the communicator 207 to obtain location information of the second user during the period from when the “Check Pick-up Location” button in the above-described reservation details screen of FIG. 7 is operated until when the “X” button in the display screen illustrating the AR image of FIG. 12 is operated. The display part F220 creates the first virtual image based on the information obtained from the server apparatus 100 and superimposes it on the first real image.

In cases where the number of the other users who are waiting for the on-demand bus 1 at the pick-up location is more than one as illustrated in FIG. 12, the user among the other users who arrived at the pick-up location earliest may be selected as the second user. If the user among the other users who arrived at the pick-up location first leaves the pick-up location before the arrival of the on-demand bus 1, the user among the other users who arrived at the pick-up location second earliest may be re-selected as the second user.

While in the example illustrated in FIG. 12, the first virtual image is an image of a frame surrounding the second user, the first image may be an image other than the frame image. For example, the first virtual image may be an image that paints second user in a specific color.

The apparatus according to the third modification can achieve advantageous effects similar to those of the apparatus according to the embodiment.

### <Others>

The above embodiment and its modifications have been described only by way of example. The technology disclosed herein can be implemented in modified manners without departing from the essence of this disclosure. Processing and features that have been described in the above description of the embodiment and its modifications may be employed in any combination so long as it is technically feasible to do so. For example, the features of the embodiment and the first to third modifications may be employed together.

One or some of the processes that have been described as processes performed by one apparatus may be performed by a plurality of apparatuses in a distributed manner. For example, the processing executed in the user's terminal 200 may be partly executed by the server apparatus 100. For example, the processing of creating an AR image may be executed by the server apparatus 100. The hardware configuration employed to implement various functions in a computer system may be modified flexibly.

The information processing apparatus disclosed herein is not limited to a mobile terminal such as a smartphone or a tablet terminal described in the above description of the embodiment and the modifications. For example, the information processing apparatus may be smart glasses provided with an optical see-through display device. In this case, the processor of the smart glasses may cause the display device to display the first virtual image at the position thereon corresponding to the pick-up location in the first real scene seen through the display device.

The technology disclosed herein can be implemented by supplying a computer program(s) that implements the functions described in the above description of the embodiment to a computer to cause one or more processors of the computer to read and execute the program(s). Such a computer program(s) may be supplied to the computer by a non-transitory, computer-readable storage medium that can be connected to a system bus of the computer, or through a network. The non-transitory, computer readable storage medium is a recording medium that can store information such as data and programs electrically, magnetically, optically, mechanically, or chemically in a computer-readable manner. Examples of such a recording medium include any type of discs including magnetic discs, such as a floppy disc (registered trademark) and a hard disk drive (HDD), and optical discs, such as a CD-ROM, a DVD, and a Blu-ray disc. The recording medium may also be a read-only memory (ROM), a random access memory (RAM), an EPROM, an EEPROM, a magnetic card, a flash memory, an optical card, or a solid state drive (SSD).

What is claimed is:

1. An information processing apparatus carried by a first user who is arranged to get on an on-demand bus, comprising:
a display device capable of displaying information; and
a controller including at least one processor, configured to cause the display apparatus to display a first virtual image indicating a bus stop in association with a first real scene including the pick-up location for the first user.

2. The information processing apparatus according to claim 1, wherein the controller is configured to cause the display device to display a second virtual image indicating a location at which the first user is to wait until the on-demand bus arrives at the pick-up location in association with the first real scene in addition to the first virtual image.

3. The information processing apparatus according to claim 1, wherein the controller is configured to cause the display device to display a third virtual image indicating the place of the first user in the boarding order in association with the first real scene in addition to the first virtual image.

4. The information processing apparatus according to claim 1, wherein the controller is configured to cause the display device to display a fourth virtual image indicating the number of other users who are waiting for the on-demand bus at the pick-up location in association with the first real scene in addition to the first virtual image.

5. The information processing apparatus according to claim 1, wherein the controller is configured to cause the display device to display a fifth virtual image marking another user who is waiting for the on-demand bus at the pick-up location in association with the first real scene in addition to the first virtual image.

6. The information processing apparatus according to claim 1, wherein the first virtual image is an image representing a bus stop sign.

7. The information processing apparatus according to claim 1, wherein the first virtual image is an image marking a second user who is one of other users waiting for the on-demand but at the pick-up location.

8. The information processing apparatus according to claim 7, wherein the second user is the user among the other users waiting for the on-demand bus at the pick-up location who arrived at the pick-up location earliest.

9. The information processing apparatus according to claim 8, wherein the controller is configured to select the other user who arrived at the pick-up location second earliest as the second user, if the other user who arrived at the pick-up location earliest leaves the pick-up location.

10. The information processing apparatus according to claim 1 further comprising a camera that photographs the first real scene to produce a first real image, wherein the controller is configured to executes the processing of:
creating an AR image in which the first virtual image is superimposed on the first real image at the position corresponding to the pick-up location in it; and
causing the display device to display the AR image.

11. A non-transitory storage medium storing a program configured to cause a computer carried by a first user arranged to get on an on-demand bus to display a first virtual image indicating a bus stop on a display device in association with a first real scene including the pick-up location for the first user.

12. The non-transitory storage medium according to claim 11, wherein the program is configured to cause the computer to display a second virtual image indicating a location at which the first user is to wait until the on-demand bus arrives at the pick-up location on the display device in association with the first real scene in addition to the first virtual image.

13. The non-transitory storage medium according to claim 11, wherein the program is configured to cause the computer to display a third virtual image indicating the place of the first user in the boarding order on the display device in association with the first real scene in addition to the first virtual image.

14. The non-transitory storage medium according to claim 11, wherein the program is configured to cause the computer to display a fourth virtual image indicating the number of other users who are waiting for the on-demand bus at the pick-up location on the display device in association with the first real scene in addition to the first virtual image.

15. The non-transitory storage medium according to claim 11, wherein the program is configured to cause the computer to display a fifth virtual image marking another user who is waiting for the on-demand bus at the pick-up location on the display device in association with the first real scene in addition to the first virtual image.

16. The non-transitory storage medium according to claim 11, wherein the first virtual image is an image representing a bus stop sign.

17. The non-transitory storage medium according to claim 11, wherein the first virtual image is an image marking a second user who is one of other users waiting for the on-demand but at the pick-up location.

18. The non-transitory storage medium according to claim 17, wherein the second user is the user among the other users waiting for the on-demand bus at the pick-up location who arrived at the pick-up location earliest.

19. The non-transitory storage medium according to claim 18, wherein the program is configured to cause the computer to select the other user who arrived at the pick-up location second earliest as the second user, if the other user who arrived at the pick-up location earliest leaves the pick-up location.

20. The non-transitory storage medium according to claim 11, wherein the computer further comprises a camera that photographs the first real scene to produce a first real image, and the program is configured to cause the computer to execute the processing of:
creating an AR image in which the first virtual image is superimposed on the first real image at the position corresponding to the pick-up location in it; and
displaying the AR image on the display device.
